(19) United States
(12) Patent Application Publication
(10) Pub. No.: US 2019/0253563 A1
(43) Pub. Date: Aug. 15, 2019

(54) Time-Bounded Network Subscriptions

(71) Applicant: Telefonaktiebolaget LM Ericsson (publ), Stockholm (SE)

(72) Inventors: Kazi Wali Ullah, Espoo (FI); Patrik Salmela, Espoo (FI)

(21) Appl. No.: 16/338,570

(22) PCT Filed: Oct. 21, 2016
(86) PCT No.: PCT/EP2016/075433

§ 371 Date: Apr. 1, 2019

(51) Int. Cl. H04M 15/00; G06F 16/9538; H04M 15/02; H04W 8/20; H04W 4/24; H04W 4/50

(52) U.S. Cl. CPC H04M 15/705; G06F 16/9538; H04M 15/888; H04M 15/725; H04W 12/06; H04W 4/24; H04M 15/715; H04W 4/50; H04W 8/20

(57) ABSTRACT

There is provided mechanisms for providing a subscriber entity with a time-bounded network subscription. The method is performed by a mobile network operator entity of the subscriber entity. The method comprises receiving a request for a time-bounded network subscription for the subscriber entity. The time-bounded network subscription is to be limited to a specified time period. The method comprises providing, to a subscription management entity, subscription information of the time-bounded network subscription. The subscription information comprises a parameter indicating that the time-bounded network subscription is to be limited to the specified time period.

### TECHNICAL FIELD

Embodiments presented herein relate to methods, a system, a mobile network operator entity, a subscription management entity, a profile handling unit, computer programs, and a computer program product for providing a subscriber entity with a time-bounded network subscription.

### BACKGROUND

Mobile networks are being used to connect all sorts of devices; automated reading of utility meters, intelligent connectivity of cars and commercial vehicles to enable drivers to access navigation, infotainment or breakdown services, traffic lights, home security and assisted living.

A subscriber identity module or subscriber identification module (SIM) is an integrated circuit chip that is intended to securely store the international mobile subscriber identity (IMSI) number and its related key, as well as other information relevant for the subscription, which is used to identify and authenticate subscriptions on the devices. The SIM circuit is part of the function of a Universal Integrated Circuit Card (UICC) physical smart card.

The GSM Association (GSMA), where GSM is short for Global System for Mobile communications, has released a technical specification denoted SGP.22—RSP defining remote SIM provisioning for consumer devices and a technical specification denoted SGP.02 disclosing a remote provisioning architecture for embedded UICC (eUICC), which targets machine-to-machine (M2M) type communications devices. In short, the operator uses an entity called SM-DP+/SM-DP (where SM-DP is short for Subscription Management-Data Preparation) for creation of SIM profiles that are later installed from the SM-DP/SM-DP+ to the eUICC. For the consumer devices, the profile is installed through a Local Profile Assistant (LPA) on the consumer device to the Issuer Security Domain Profile (ISD-P) on the eUICC in the device. For the M2M devices, the SM-DP installs the profile via a separate (external) entity, SM-SR, to the ISD-P on the device.

Both above mentioned variants have the device owner obtaining a subscription for the device from the operator by providing the operator with relevant information about the device to be provisioned, optionally including eUICC ID (EID) and International Mobile Station Equipment Identity (IMEI). The subscription can be obtained from a point of sales, via a web page of the operator, or other similar methods. Section 3.1 in SGP.22 describes the profile download initiation process. It shows how the user orders a subscription from the operator, and how the operator asks the SM-DP+ to generate the matching profile. Then the operator provides the user with an activation code (AC) that the user can insert into/provide to the device to be provisioned. The device can extract the relevant information (SM-DP+ reachability information, etc.) from the activation code and then proceed to contact the SM-DP+ for downloading the profile based on the AC after mutual authentication and various security functions.

Network subscriptions could be inflexible in terms of binding periods.

Hence, there is a need for an improved handling of network subscriptions.

### SUMMARY

An object of embodiments herein is to provide flexible handling of network subscriptions.

According to a first aspect there is presented a method for providing a subscriber entity with a time-bounded network subscription. The method is performed by a mobile network operator (MNO) entity of the subscriber entity. The method comprises receiving a request for a time-bounded network subscription for the subscriber entity. The time-bounded network subscription is to be limited to a specified time period. The method comprises providing, to a subscription management entity, subscription information of the time-bounded network subscription. The subscription information comprises a parameter indicating that the time-bounded network subscription is to be limited to the specified time period.

According to a second aspect there is presented an MNO entity for providing a subscriber entity with a time-bounded network subscription. The MNO entity comprises processing circuitry. The processing circuitry is configured to cause the MNO entity to receive a request for a time-bounded network subscription for the subscriber entity. The time-bounded network subscription is to be limited to a specified time period. The processing circuitry is configured to cause the MNO entity to provide, to a subscription management entity, subscription information of the time-bounded network subscription. The subscription information comprises a parameter indicating to that the time-bounded network subscription is to be limited to the specified time period.

According to a third aspect there is presented an MNO entity for providing a subscriber entity with a time-bounded network subscription. The MNO entity comprises processing circuitry and a storage medium. The storage medium stores instructions that, when executed by the processing circuitry, cause the MNO entity to perform operations, or steps. The operations, or steps, cause the MNO entity to receive a request for a time-bounded network subscription for the subscriber entity. The time-bounded network subscription is to be limited to a specified time period. The operations, or steps, cause the MNO entity to provide, to a subscription management entity, subscription information of the time-bounded network subscription. The subscription information comprises a parameter indicating that the time-bounded network subscription is to be limited to the specified time period.

According to a fourth aspect there is presented an MNO entity for providing a subscriber entity with a time-bounded network subscription. The MNO entity comprises a receive module configured to receive a request for a time-bounded network subscription for the subscriber entity. The time-bounded network subscription is to be limited to a specified time period. The MNO entity comprises a provide module configured to provide, to a subscription management entity, subscription information of the time-bounded network subscription. The subscription information comprises a parameter indicating that the time-bounded network subscription is to be limited to the specified time period.

According to a fifth aspect there is presented a computer program for providing a subscriber entity with a time-bounded network subscription, the computer program comprising computer program code which, when run on processing circuitry of a mobile network operator entity, causes the mobile network operator entity to perform a method according to the first aspect.

According to a sixth aspect there is presented a method for providing a subscriber entity with a time-bounded network subscription. The method is performed by a subscription management entity. The method comprises obtaining, from an MNO entity of the subscriber entity, subscription information of a time-bounded network subscription for the subscriber entity. The subscription information comprises a parameter indicating that the time-bounded network subscription is to be limited to a specified time period. The method comprises generating a profile for the time-bounded network subscription. The profile comprises metadata defining the specified time period. The method comprises enabling download of the profile to a profile handling unit of the subscriber entity.

According to a seventh aspect there is presented a subscription management entity for providing a subscriber entity with a time-bounded network subscription. The subscription management entity comprises processing circuitry. The processing circuitry is configured to cause the subscription management entity to obtain, from an MNO entity of the subscriber entity, subscription information of a time-bounded network subscription for the subscriber entity. The subscription information comprises a parameter indicating that the time-bounded network subscription is to be limited to a specified time period. The processing circuitry is configured to cause the subscription management entity to generate a profile for the time-bounded network subscription. The profile comprises metadata defining the specified time period. The processing circuitry is configured to cause the subscription management entity to enable download of the profile to a profile handling unit of the subscriber entity.

According to an eighth aspect there is presented a subscription management entity for providing a subscriber entity with a time-bounded network subscription. The subscription management entity comprises processing circuitry and a storage medium. The storage medium stores instructions that, when executed by the processing circuitry, cause the subscription management entity to perform operations, or steps. The operations, or steps, cause the subscription management entity to obtain, from an MNO entity of the subscriber entity, subscription information of a time-bounded network subscription for the subscriber entity. The subscription information comprises a parameter indicating that the time-bounded network subscription is to be limited to a specified time period. The operations, or steps, cause the subscription management entity to generate a profile for the time-bounded network subscription. The profile comprises metadata defining the specified time period. The operations, or steps, cause the subscription management entity to enable download of the profile to a profile handling unit of the subscriber entity.

According to a ninth aspect there is presented a subscription management entity for providing a subscriber entity with a time-bounded network subscription. The subscription management entity comprises an obtain module configured to obtain, from an MNO entity of the subscriber entity, subscription information of a time-bounded network subscription for the subscriber entity. The subscription information comprises a parameter indicating that the time-bounded network subscription is to be limited to a specified time period. The subscription management entity comprises a generate module configured to generate a profile for the time-bounded network subscription. The profile comprises metadata defining the specified time period. The subscription management entity comprises an enable module configured to enable download of the profile to a profile handling unit of the subscriber entity.

According to a tenth aspect there is presented a computer program for providing a subscriber entity with a time-bounded network subscription, the computer program comprising computer program code which, when run on processing circuitry of a subscription management entity, causes the subscription management entity to perform a method according to the sixth aspect.

According to an eleventh aspect there is presented a method for providing a subscriber entity with a time-bounded network subscription. The method is performed by a profile handling unit of the subscriber entity The method comprises downloading a profile of the time-bounded network subscription from a subscription management entity. The profile comprises metadata defining a specified time period for which the time-bounded network subscription is to be limited. The method comprises storing the metadata. The method comprises removing the profile from the subscriber entity upon expiry of the specified time period.

According to a twelfth aspect there is presented a profile handling unit for providing a subscriber entity with a time-bounded network subscription. The profile handling unit comprises processing circuitry. The processing circuitry is configured to cause the profile handling unit to download a profile of the time-bounded network subscription from a subscription management entity. The profile comprises metadata defines a specified time period for which the time-bounded network subscription is to be limited. The processing circuitry is configured to cause the profile handling unit to store the metadata. The processing circuitry is configured to cause the profile handling unit to remove the profile from the subscriber entity upon expiry of the specified time period.

According to a thirteenth aspect there is presented a profile handling unit for providing a subscriber entity with a time-bounded network subscription. The profile handling unit comprises processing circuitry and a storage medium. The storage medium stores instructions that, when executed by the processing circuitry, cause the profile handling unit to perform operations, or steps. The operations, or steps, cause the profile handling unit to download a profile of the time-bounded network subscription from a subscription management entity. The profile comprises metadata defining a specified time period for which the time-bounded network subscription is to be limited. The operations, or steps, cause the profile handling unit to store the metadata. The operations, or steps, cause the profile handling unit to remove the profile from the subscriber entity upon expiry of the specified time period.

According to a fourteenth aspect there is presented a profile handling unit for providing a subscriber entity with a time-bounded network subscription. The profile handling unit comprises a download module configured to download a profile of the time-bounded network subscription from a subscription management entity. The profile comprises metadata defining a specified time period for which the time-bounded network subscription is to be limited. The profile handling unit comprises a store module configured to store the metadata. The profile handling unit comprises a remove module configured to remove the profile from the subscriber entity upon expiry of the specified time period.

According to a fifteenth aspect there is presented a computer program for providing a subscriber entity with a time-bounded network subscription, the computer program comprising computer program code which, when run on processing circuitry of a profile handling unit, causes the profile handling unit to perform a method according to the eleventh aspect.

According to a sixteenth aspect there is presented a computer program product comprising a computer program according to at least one of the fifth aspect, the tenth aspect, and the fifteenth aspect and a computer readable storage medium on which the computer program is stored. The computer readable storage medium can be a non-transitory computer readable storage medium.

According to a seventeenth aspect there is presented a system for providing a subscriber entity with a time-bounded network subscription. The system comprises an MNO entity, a subscription management entity, and a profile handling unit. The MNO entity is configured to receive a request for a time-bounded network subscription for the subscriber entity. The time-bounded network subscription is to be limited to a specified time period. The MNO entity is configured to provide, and the subscription management entity is configured to obtain, subscription information of the time-bounded network subscription. The subscription information comprises a parameter indicating that the time-bounded network subscription is to be limited to the specified time period. The subscription management entity is configured to generate a profile for the time-bounded network subscription. The profile comprises metadata defining the specified time period. The profile handling unit of the subscriber entity is configured to download the profile from the subscription management entity and store the metadata. The profile handling unit is configured to remove the profile from the subscriber entity upon expiry of the specified time period.

Advantageously these methods, this mobile network operator entity, this subscription management entity, this profile handling unit, this system, and these computer programs provide efficient handling of the time-bounded network subscription of the subscriber entity.

Advantageously these methods, this mobile network operator entity, this subscription management entity, this profile handling unit, this system, and these computer programs enable the user or MNO to generate time-bounded profiles/subscriptions and allow the profile handling unit, as well as the MNO, to automatically terminate the subscription (and billing thereof) after the specified time period.

Advantageously these methods, this mobile network operator entity, this subscription management entity, this profile handling unit, this system, and these computer programs enable efficient profile lifecycle management.

It is to be noted that any feature of the first, second, third, fourth, fifth, sixth seventh, eight, ninth, tenth, eleventh, twelfth, thirteen, fourteenth, fifteenth sixteenth and seventeenth aspects may be applied to any other aspect, wherever appropriate. Likewise, any advantage of the first aspect may equally apply to the second, third, fourth, fifth, sixth, seventh, eight, ninth, tenth, eleventh twelfth, thirteen, fourteenth, fifteenth, sixteenth, and seventeenth aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIGS. 2, 3, 4, 5, 6, 7, 9, and 10 are flowcharts of methods according to embodiments;

FIG. 8 is a signalling diagram according to an embodiment;

FIG. 11 is a schematic diagram showing functional units of a mobile network operator entity according to an embodiment;

FIG. 12 is a schematic diagram showing functional modules of a mobile network operator entity according to an embodiment;

FIG. 13 is a schematic diagram showing functional units of a subscription management entity according to an embodiment;

FIG. 14 is a schematic diagram showing functional modules of a subscription management entity according to an embodiment;

FIG. 15 is a schematic diagram showing functional units of a profile handling unit according to an embodiment;

FIG. 16 is a schematic diagram showing functional modules of a profile handling unit according to an embodiment; and

FIG. 17 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

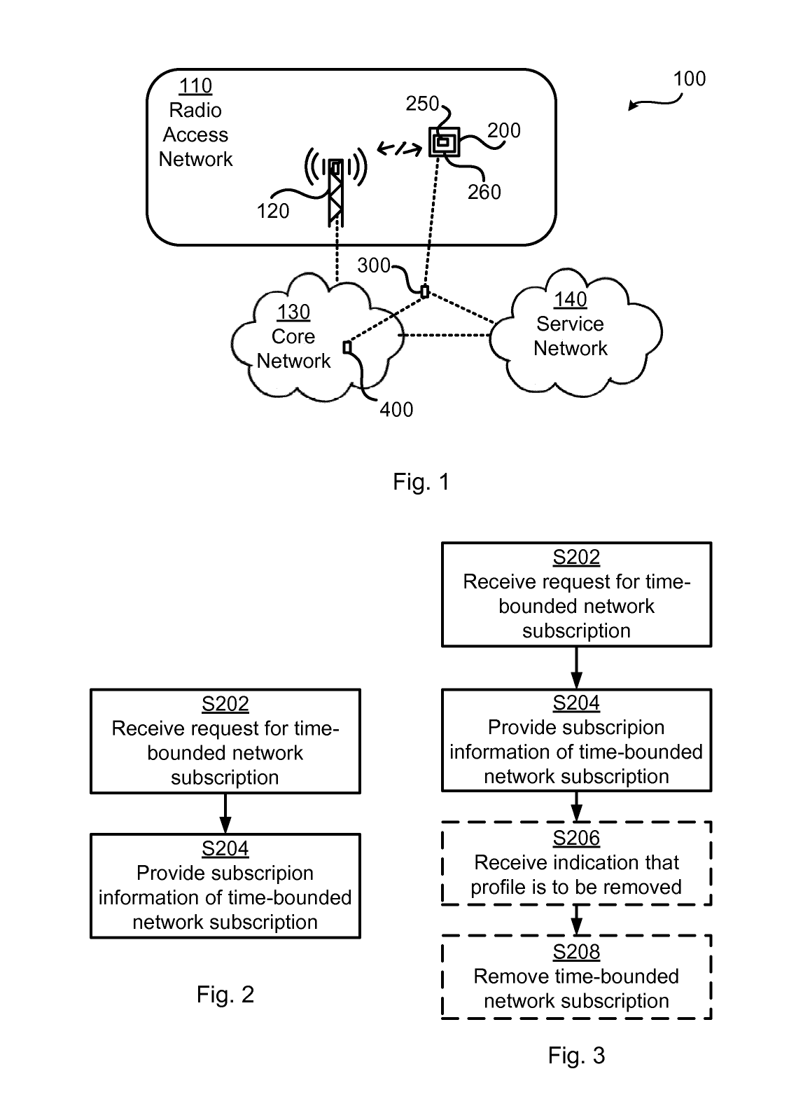

FIG. 1 is a schematic simplified diagram of a communications network 100 where embodiments presented herein can be applied. The communications network 100 comprises a radio access network 110 (defined by a radio access network node 120, such as a radio base station), a core network 130, and a packet based service network 140. The core network 130 operatively connects the radio access network 110 with the packet based service network 140.

A subscriber entity 200 operatively connected to the packet based service network 140, for example via radio access network node 120, via WiFi, or via some other wireless or fixed-wired network access, is thereby enabled to access services and exchange data with the service network 140.

The subscriber entity 200 comprises a profile handling unit, which could be provided as an Issuer Security Domain Root (ISD-R) function 250, or just ISD-R for short, and an Embedded Universal Integrated Circuit Card (eUICC) 260. According to some aspects the ISD-R 250 is provided within the eUICC 260. Functions of an embedded SIM (eSIM, e-SIM, or virtual SIM) circuit could be part of the function of the eUICC 260.

At least the radio access network 110 and the core network 130 are operated by one or more mobile network operators (MNOs), schematically illustrated by the mobile network operator entity 400.

The communications network 100 further comprises at least one subscription management entity 300. The subscription management entity 300 could be located in the core network 130, in the service network 140, or outside the core network 130 and the service network 140; the herein disclosed embodiments are not limited to any particular location of the subscription management entity 300. Each such subscription management entity 300 could be implemented in an SM-DP+ entity. Functionality of the subscription management entity 300 in relation to the herein disclosed embodiments will be disclosed below.

Dotted lines in FIG. 1 indicate operational connections.

Network subscriptions could be time-bounded and thus have a specific validity time, meaning that the network subscription will be terminated from the device and/or from the network automatically after the validity time has expired. It could be possible to delete subscription information from the MNO side to disable network access of the network subscription after a specific amount of time. But the above-mentioned specification SGP.22 does not provide any details regarding handling of such time-bounded network subscriptions.

The network subscription of the subscriber entity 200 could thus be time-bounded and thus have a specific validity time, meaning that the network subscription will be terminated from the subscriber entity 200 and/or from the network automatically after the validity time has expired. Although it could be possible to delete subscription information from the MNO side to disable network access of the network subscription after a specific amount of time, profile related data could still remain in the subscriber entity 200.

In short, at least some of the embodiments disclosed herein are based on including a time related parameter during the download and installation of the profile to the subscriber entity 200 from the subscription management entity 300. Some of the embodiments disclosed herein are related to how this time related parameter can be generated and used to implement a time bounded profile usage. The subscription/profile can thereby be efficiently deleted from the mobile network operator entity 400 as well as the subscriber entity 200 once the validity time expires.

The embodiments disclosed herein thus relate to mechanisms for providing a subscriber entity 200 with a time-bounded network subscription. In order to obtain such mechanisms there is provided a mobile network operator entity 400, a method performed by the mobile network operator entity 400, a computer program product comprising code, for example in the form of a computer program, that when run on processing circuitry of the mobile network operator entity 400, causes the mobile network operator entity 400 to perform the method. In order to obtain such mechanisms there is further provided a subscription management entity 300, a method performed by the subscription management entity 300, and a computer program product comprising code, for example in the form of a computer program, that when run on processing circuitry of the subscription management entity 300, causes the subscription management entity 300 to perform the method. In order to obtain such mechanisms there is further provided a profile handling unit 250, 260, a method performed by the profile handling unit 250, 260, and a computer program product comprising code, for example in the form of a computer program, that when run on processing circuitry of the profile handling unit 250, 260, causes the profile handling unit 250, 260 to perform the method.

Reference is now made to FIG. 2 illustrating a method for providing a subscriber entity 200 with a time-bounded network subscription as performed by the mobile network operator entity 400 of the subscriber entity 200 according to an embodiment.

S202: The mobile network operator entity 400 receives a request for a time-bounded network subscription for the subscriber entity 200. The time-bounded network subscription is to be limited to a specified time period.

S204: The mobile network operator entity 400 provides, to the subscription management entity 300, subscription information of the time-bounded network subscription. The subscription information comprises a parameter indicating that the time-bounded network subscription is to be limited to the specified time period.

According to an embodiment the subscription information of the time-bounded network subscription is provided to the subscription management entity 300 as part of a request for the subscription management entity 300 to generate the profile for the subscriber entity 200.

Reference is now made to FIG. 3 illustrating methods for providing a subscriber entity 200 with a time-bounded network subscription as performed by the mobile network operator entity 400 according to further embodiments. It is assumed that steps S202, S204 are performed as described above with reference to FIG. 2 and a thus repeated description thereof is therefore omitted.

There may be different ways for the mobile network operator entity 400 to act once the specified time period has been expired.

The mobile network operator entity 400 could be configured to trust that the profile handling unit 250, 260 keeps track of the lifetime of the profile and removes the profile locally (by removing the corresponding profile from the subscriber entity 200) upon expiry of the specified time period.

As an example, the eUICC/ISD-R could inform the MNO that the profile is to be removed from the eUICC/ISD-R. Hence, according to an embodiment the mobile network operator entity 400 is configured to perform step S206:

S206: The mobile network operator entity 400 receives an indication from the profile handling unit 250, 260 of the subscriber entity 200 that the profile is to be removed from the subscriber entity 200.

The mobile network operator entity 400 could then remove the time-bounded network subscription. Hence, according to an embodiment the mobile network operator entity 400 is configured to perform step S208:

S208: The mobile network operator entity 400 removes the time-bounded network subscription from the mobile network operator entity 400 upon expiry of the specified time period.

It is understood that the user could request the time-bounded network subscription to be removed before expiry of the specified time period. In this respect, the mobile network operator entity 400 could thus be configured to remove the time-bounded network subscription from the mobile network operator entity 400 at the earlier of expiry of the specified time period and user input explicitly requesting the time-bounded network subscription to be removed. However, if the user input signals removal of the time-bounded network subscription substantially earlier than expiry of the specified time period, the mobile network operator entity 400 could be configured to still keep the time-bounded network subscription until expiry of the specified time period (and thus to still keep track of the duration of the time-bounded network subscription) as the user could potentially request the time-bounded network subscription to be continued. The term substantially earlier could thus either be defined in relation to the duration of the time-bounded network subscription, such as at least 50% of the duration, or 25% of the duration, or be defined according to an absolute time scale, such as 1 month, 1 month, or 1 week.

Further, the mobile network operator entity 400 does not necessarily need to receive an indication from the profile handling unit 250, 260 in order for the mobile network operator entity 400 to remove the time-bounded network subscription. That is, step S208 does not necessarily need to be preceded by step S206.

Hence, the mobile network operator entity 400 could be configured to by itself keep track of the lifetime of the profile and remove the corresponding time-bounded network subscription at its end. This means that the subscription will not be valid even if an attacker manages to hack the profile to handling unit 250, 260 not to remove the profile since the network subscription will anyway be deleted from the MNO when the timer runs out.

The duration of the specified time period could be set by the MNO. Hence, according to an embodiment the specified time period has a duration set by the mobile network operator entity 400.

The mobile network operator entity 400 could store timer information (such as the parameter indicating that the time-bounded network subscription is to be limited to the specified time period) with other subscription information in order for the mobile network operator entity 400 to be able to enforce the timer. For example, the mobile network operator entity 400 could have a parameter that indicates whether the profile has been activated (if first network attach has been done) or not. When a network authentication procedure is performed, and the mobile network operator entity 400 notices that there is a timer set for the subscription, but the timer has not been started (i.e., the profile has not been activated), the mobile network operator entity 400 will start the timer at this point; if the duration of the specified time period is given as a timestamp (see below) there is no need for the mobile network operator entity 400 to start such a timer when the network authentication procedure is performed but only to remove the time-bounded network subscription in accordance with the timestamp. Further, if the timer is started at download of the profile (see, steps S310, S404, S108 below) the profile handling unit 250, 260 upon download of the profile could be configured to notify the mobile network operator entity 400 that the profile has been downloaded and that the timer has been started in order for the mobile network operator entity 400 to start its own timer (and synchronize it with the timer of the profile handling unit 250, 260).

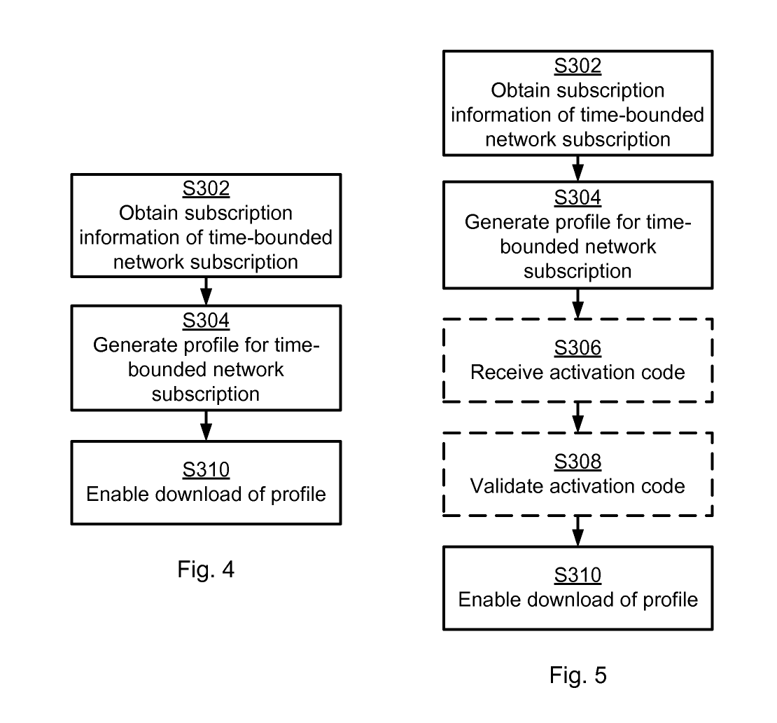

Reference is now made to FIG. 4 illustrating a method for providing a subscriber entity 200 with a time-bounded network subscription as performed by the subscription management entity 300 according to an embodiment.

As disclosed above, the mobile network operator entity 400 in step S204 provides subscription information of the time-bounded network subscription to the subscription management entity 300. It is assumed that the subscription information is received by the subscription management entity 300. Hence, the subscription management entity 300 is configured to perform step S302:

S302: The subscription management entity 300 obtains, from the mobile network operator entity 400 of the subscriber entity 200, subscription information of a time-bounded network subscription for the subscriber entity 200. As disclosed above, the subscription information comprises a parameter indicating that the time-bounded network subscription is to be limited to a specified time period.

Once having obtained the subscription information the subscription management entity 300 could generate a profile for the time-bounded network subscription based on the subscription information. In particular, the subscription management entity 300 is configured to perform step S304:

S304: The subscription management entity 300 generates a profile for the time-bounded network subscription. The profile comprises metadata defining the specified time period.

The profile needs to be downloaded to the profile handling unit 250, 260 in order for the subscriber entity 200 to be able to use the time-bounded network subscription. Hence, the subscription management entity 300 is configured to perform step S310:

S310: The subscription management entity 300 enables download of the profile to the profile handling unit 250, 260 of the subscriber entity 200.

The profile as generated by the subscription management entity 300 in step S304 could take several forms from generation till download to the profile handling unit 250, 260. First, an unprotected profile package (UPP) could be generated from the subscription information received from the mobile network operator entity 400. The UPP could comprise a raw SIMalliance Tag Length Value (TLV) sequence. Then, a protected profile package (PPP) could be generated (by the subscription management entity 300) from the raw TLV sequence by segmenting and protecting raw TLV sequence using a Secure Channel Protocol (SCP03t). Finally, a bounded profile package (BPP) could be generated (by the subscription management entity 300) which links the PPP to a specific eUICC. This is done within a key agreement between the eUICC and the SM-DP+. The profile metadata defining the specified time period could then be added to the BPP. Hence, according to an embodiment the metadata is provided in the BPP.

Reference is now made to FIG. 5 illustrating methods for providing a subscriber entity 200 with a time-bounded network subscription as performed by the subscription management entity 300 according to further embodiments. It is assumed that steps S302, S304, S310 are performed as described above with reference to FIG. 4 and a thus repeated description thereof is therefore omitted.

There may be different ways for the subscription management entity 300 to enable download of the profile to the profile handling unit 250, 260. According to some aspects, download is only allowed if a valid activation code token is presented to the subscription management entity 300. Hence, according to an embodiment the subscription management entity 300 is configured to perform steps S306 and S308:

S306: The subscription management entity 300 receives an activation code token for the profile from the profile handling unit 250, 260.

S308: The subscription management entity 300 validates the activation code token.

Download of the profile is then only enabled if the activation code is found valid by the subscription management entity 300. Activation code tokens for profiles of network subscriptions are as such known in the art and further description thereof is therefore omitted.

The duration of the specified time period could be set by the SM-DP+. Hence, to according to an embodiment the specified time period has a duration set by the subscription management entity 300. For example, the duration could be set during the creation of a bounded profile package based on a pre-defined MNO policy. This could imply that the subscription information provided by the mobile network operator entity 400 in step S204 does not indicate the specified time period of the time-bounded network subscription and the subscription management entity 300 is enabled to select the specified time period. Alternatively, the subscription management entity 300 could be configured to override the specified time period of the time-bounded network subscription set by the mobile network operator entity 400. In either case this could result in mismatch in lifetime of the time-bounded network subscription between the subscriber entity 200 and the mobile network operator entity 400 unless the subscription management entity 300 communicates the new/updated lifetime back to the mobile network operator entity 400. Further, according to some embodiments the mobile network operator entity 400 is not made aware of the duration (lifetime) of the time-bounded network subscription and therefore relies on the profile handling unit 250, 260 indicating to the mobile network operator entity 400 when the profile is about to be removed from the subscriber entity 200.

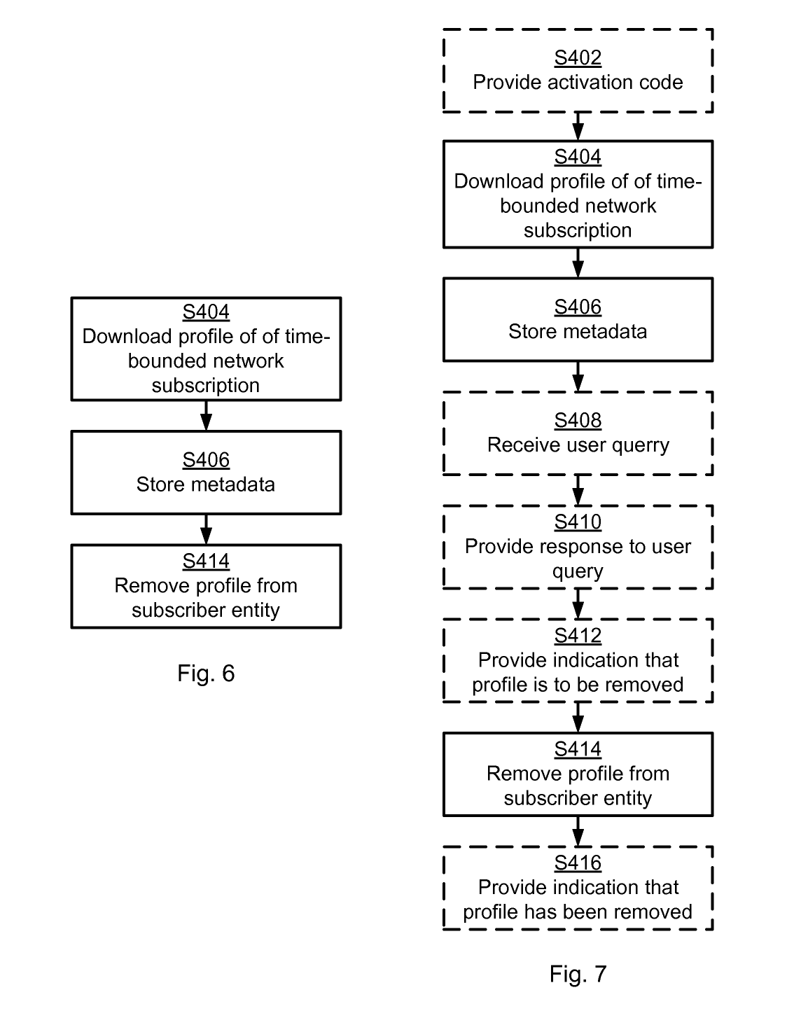

Reference is now made to FIG. 6 illustrating a method for providing a subscriber entity 200 with a time-bounded network subscription as performed by the profile handling unit 250, 260 of the subscriber entity 200 according to an embodiment.

As disclosed above, the subscription management entity 300 in step S310 enables download of the profile to the profile handling unit 250, 260. It is assumed that the profile handling unit 250, 260 downloads the profile and hence is configured to perform step S404:

S404: The profile handling unit 250, 260 downloads the profile of the time-bounded network subscription from the subscription management entity 300. As disclosed above, the profile comprises metadata defining a specified to time period for which the time-bounded network subscription is to be limited.

Once the profile of the time-bounded network subscription has been downloaded to the profile handling unit 250, 260, the profile handling unit 250, 260 stores the metadata and is hence configured to perform step S406:

S406: The profile handling unit 250, 260 stores the metadata.

Once the specified time period expires the profile handling unit 250, 260 removes the profile and is hence configured to perform step S414:

S414: The profile handling unit 250, 260 removes the profile from the subscriber entity 200 upon expiry of the specified time period.

During the download (and installation) of the profile the metadata is provided to the eUICC 260. This can be implemented using a function called StoreMetadata as disclosed in Section 5.2.2.3 in SGP.22. This function is provided by the ISD-R 250 of the eUICC 260. The defined behaviour of this function is that upon reception of this command the eUICC 260 stores the metadata for future use by the LPA so that the user can retrieve the metadata from the eUICC 260. The LPA could be able to access the metadata any time after the profile has been successfully loaded into the eUICC 260 using the GetProfilesInfoMetadata function.

As disclosed above, the metadata defines a specified time period for which the time-bounded network subscription is to be limited and this metadata is in step S406 stored alongside other metadata. Upon storage of the metadata the profile handling unit 250, 260 may start a counter, or set a marker in the ISD-R 250, to indicate that this profile has a limited lifetime. The ISD-R 250 is thereby enabled to enforce the validity of the profile since it is the ISD-R 250 that manages the lifecycle of the profile.

Reference is now made to FIG. 7 illustrating methods for providing a subscriber entity 200 with a time-bounded network subscription as performed by the profile handling unit 250, 260 according to further embodiments. It is assumed that steps S404, S406, S414 are performed as described above with reference to FIG. 6 and a thus repeated description thereof is therefore omitted.

According to some aspects, download of the profile is only allowed if a valid activation code token is presented to the subscription management entity 300. Hence, according to an embodiment the profile handling unit 250, 260 is configured to perform step S402:

S402: The profile handling unit 250, 260 provides an activation code token for the profile to the subscription management entity 300. The profile is then downloaded by the profile handling unit 250, 260 in step S404 in response to having performed step S402 (and after validation of the activation code token by the subscription management entity 300).

According to some aspects, a user of the subscriber entity 200 could query about the time-bounded network subscription, and particularly regarding the remaining time of the specified time period. Hence, according to an embodiment the profile handling unit 250, 260 is configured to perform steps S408 and S410:

S408: The profile handling unit 250, 260 receives user query about remaining time of the specified time period.

S410: The profile handling unit 250, 260 provides a response to the user query based on the metadata. The response could thus comprise an indication of the remaining time of the specified time period. This enables the LPA to present the validity time (e.g. in terms of number of seconds passed from installation of the profile or expiry date of the profile) to the user so that the user can know about the validity of the profile.

According to some aspects the profile handling unit 250, 260 informs the mobile network operator entity 400 when the profile is to be removed from the subscriber entity 200. Hence, according to an embodiment the profile to handling unit 250, 260 is configured to perform step S412:

S412: The profile handling unit 250, 260 provides an indication to the mobile network operator entity 400 of the subscriber entity 200 that the profile is to be removed from the subscriber entity 200.

The mobile network operator entity 400 could receive this indication in step S206, see above.

The signalling to the mobile network operator entity 400 could be part of the removal process of the profile. Information that the profile is to be removed from the subscriber entity 200 could be communicated to the mobile network operator entity 400 before actual removal of the profile from the subscriber entity 200, as after removal the subscriber entity 200 might not have any network connectivity. However, if the subscriber entity 200 still has network connectivity after the profile has been removed the profile handling unit 250, 260 may inform the mobile network operator entity 400 that the profile has been removed after the profile has been removed.

Further, if the mobile network operator entity 400 is aware and handles the same timer value of the time-bounded network subscription as the profile handling unit 250, 260 and is in time-wise synchronization (within a tolerance margin of error) with the profile handling unit 250, 260 there is not any need for explicit signaling between the profile handling unit 250, 260 and the mobile network operator entity 400 related to the removal of the profile/subscription.

Still further, the profile handling unit 250, 260 could inform the user when the network subscription no longer is valid. Hence, according to an embodiment the profile handling unit 250, 260 is configured to perform step S416:

S416: The profile handling unit 250, 260 provides an indication towards a user interface controller that the profile has been removed from the subscriber entity 200.

Informing the user can be done through the LPA.

Embodiments equally applicable to any of the above disclosed methods for providing the subscriber entity 200 with a time-bounded network subscription as performed by any of the mobile network operator entity 400, the subscription management entity 300, and the profile handling unit 250, 260 will now be disclosed.

As already mentioned above, there could be different ways to set the duration of the specified time period. The specified time period could have a duration set by the subscriber entity 200, the mobile network operator entity 400, the subscription management entity 300, or being defined by user input, where the user input or the subscriber entity 200 could define the entity ordering the network subscription.

There could be different ways for the specified time period to be measured. Different embodiments relating thereto will now be presented.

The duration can be given in terms of number of seconds. That is, according to an embodiment the specified time period is provided as number of seconds. The seconds could be counted from the time of provisioning of the subscription. That is, according to an embodiment the number of seconds is counted from provisioning of the time-bounded network subscription. Alternatively, the seconds could be counted from the time of first network authentication (i.e., when the profile/subscription is used for the first time). That is, according to an embodiment the number of seconds is counted from first network authentication of the profile. The mobile network operator entity 400 and the profile handling unit 250, 260 could synchronize their counters based on the first network attach procedure. One advantage of using the number of seconds as a value is that it gives the opportunity to start the validity from the installation or activation of the profile. An example range of values to count the number of seconds could be such that any positive value will indicate the number of seconds as the lifetime of the profile and a value of 0 will indicate that the profile will be valid indefinitely (until it is terminated explicitly by some other means).

Alternatively, the duration is given as a timestamp, e.g. provided in terms of date (and time) of expiry. That is, according to an embodiment the specified time period is provided as a timestamp indicating a point in time for expiry of the specified time period. The validity period can thus be presented as a timestamp which indicates the time when the profile/subscription will expire. The profile handling unit 250, 260 could therefore be configured to obtain a reliable current time from the network to compare the timer value against in order to determine when the specified time period has expired. One advantage of using a timestamp to indicate the point in time for expiry of the specified time period is that explicit communication regarding termination and removal of the profile between the profile handling unit 250, 260 and the mobile network operator entity 400 can be minimized.

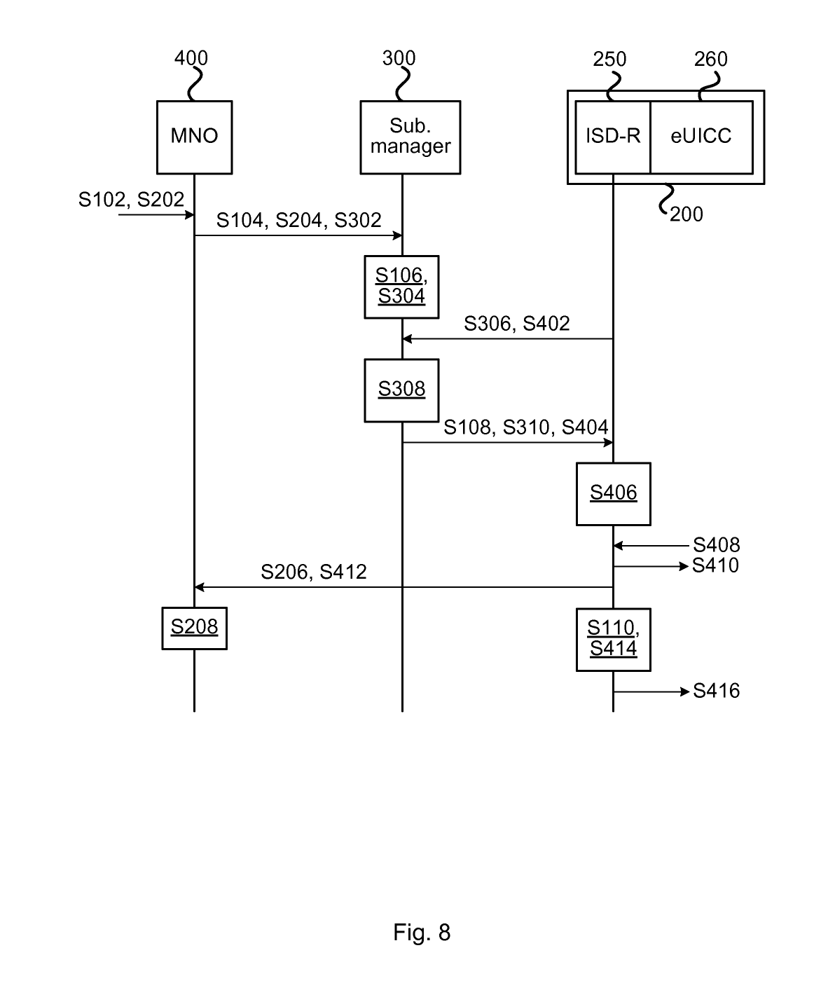

FIG. 8 is a signalling diagram of a method for providing a subscriber entity 200 with a time-bounded network subscription as performed by the mobile network operator entity 400, the subscription management entity 300, and the profile handling unit 250, 260.

S102, S202: The mobile network operator entity 400 receives a request for a time-bounded network subscription for the subscriber entity 200. The time-bounded network subscription is to be limited to a specified time period.

S104, S204, S302: The mobile network operator entity 400 provides, and the subscription management entity 300 obtains, subscription information of the time-bounded network subscription. The subscription information comprises a parameter indicating that the time-bounded network subscription is to be limited to the specified time period.

S106, S304: The subscription management entity 300 generates a profile for the time-bounded network subscription. The profile comprises metadata defining the specified time period.

S108, S310, S404: The profile handling unit 250, 260 downloads the profile from the subscription management entity 300 and stores the metadata. The subscription management entity 300 enables such download.

S110, S414: The profile handling unit 250, 260 removes the profile from the subscriber entity 200 upon expiry of the specified time period.

Removing subscription data from the subscriber entity 200 (along with removing subscription data at the network side) will allow the MNO to reuse some of the subscription information (e.g. IMSI) to generate a new profile without having to deal with possible conflicts (e.g. two subscriptions with same IMSI, one that can authenticate with it and the other which cannot).

Steps S206, S208, S306, S402, S406, S408, S410, S412, S416 are performed as disclosed above with reference to FIGS. 3, 5, and 7.

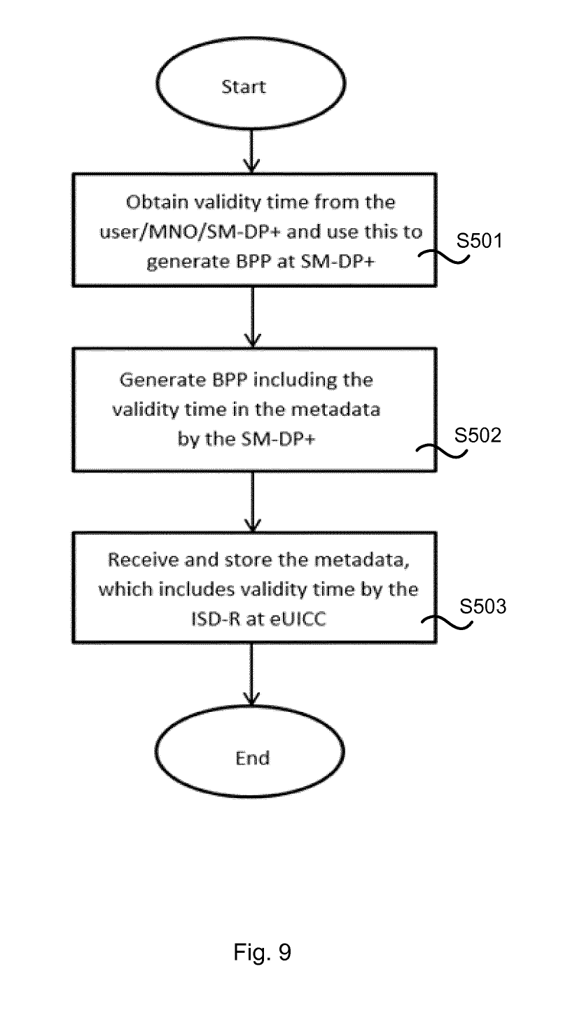

One particular embodiment for generating and storing a time-bounded network subscription based on at least some of the above disclosed embodiments will now be disclosed in detail with reference to the flow chart of FIG. 9.

S501: A parameter indicating that the time-bounded network subscription is to be limited to a specified time period is obtained from the subscriber entity 200, the subscription management entity 300, or user input. Alternatively, the parameter is derived by the mobile network operator entity 400 upon receiving the request for the time-bounded network subscription for the subscriber entity 200. A validity time from the user, MNO, or SM-DP+ is thus obtained for a BPP to be generated.

S502: The subscription management entity 300 generates a profile for the time-bounded network subscription. The profile comprises metadata defining the specified time period. The SM-DP+ could thus generate the BPP and include in the metadata of the BPP the validity timer.

S503: The profile handling unit 250, 260 receives and stores the metadata when downloading the profile from the subscription management entity 300. The ISD-R 250 in the eUICC 260 could thus receive and store the metadata including the validity timer.

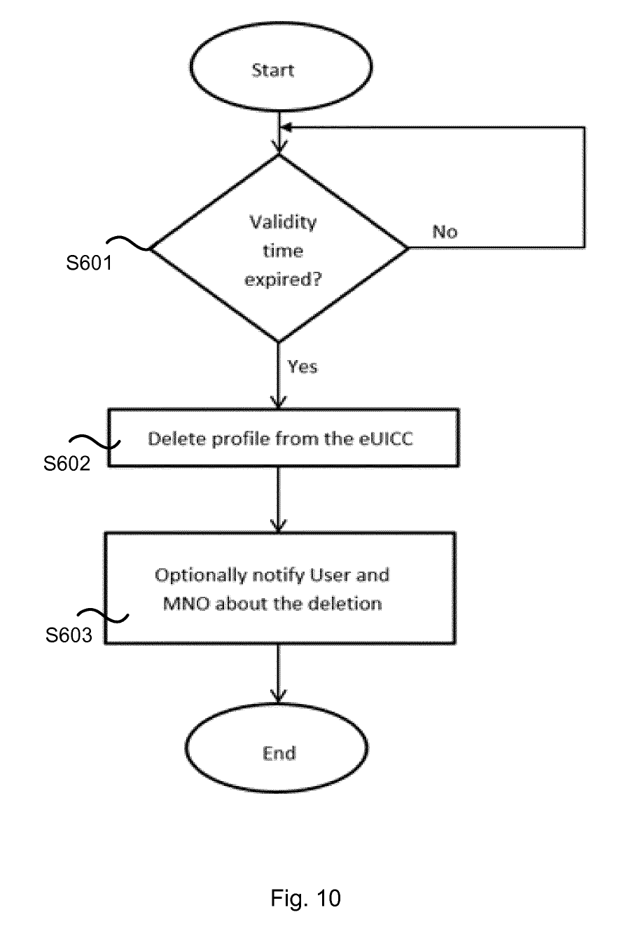

One particular embodiment for determining whether to remove the profile from the subscriber entity 200 based on at least some of the above disclosed embodiments will now be disclosed in detail with reference to the flow chart of FIG. 10.

S601: The profile handling unit 250, 260 checks if the validity time of the time-bounded network subscription has expired based on the specified time period. If yes, step S602 is entered. If no, step S601 is entered again after a time delay.

S602: The profile handling unit 250, 260 removes the profile from the subscriber entity 200 upon expiry of the specified time period.

S603: The profile handling unit 250, 260 optionally informs the user and/or the mobile network operator entity 400 about the removal.

The order in which steps S602 and S603 are performed could be reversed.

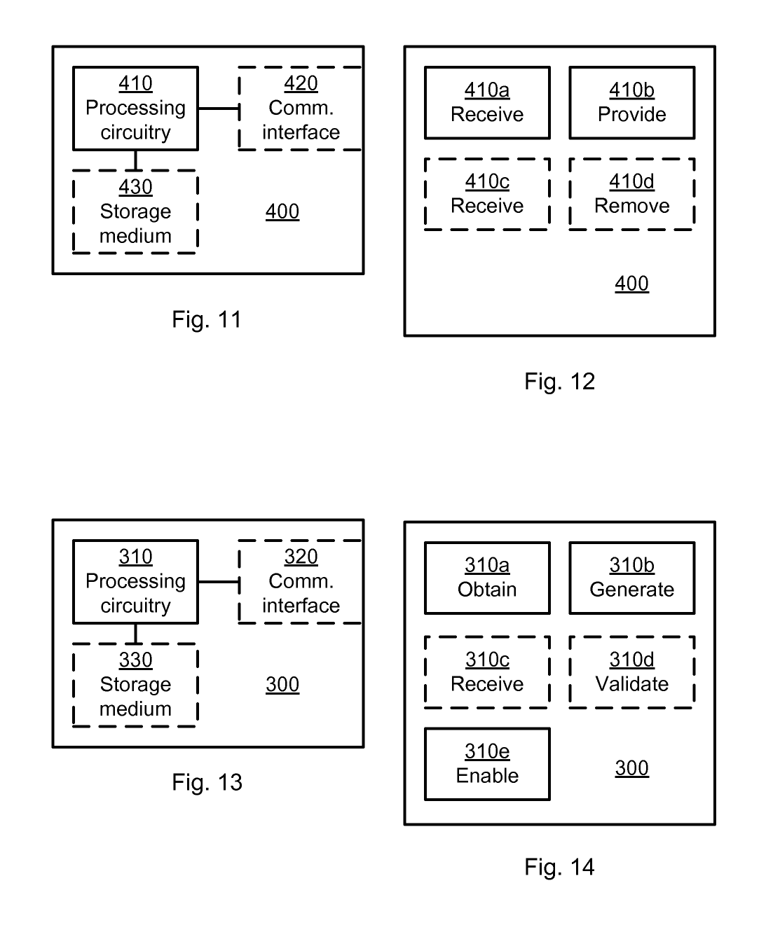

FIG. 11 schematically illustrates, in terms of a number of functional units, the components of a mobile network operator entity 400 according to an embodiment. Processing circuitry 410 is provided using any combination of one or more of a suitable central processing unit (CPU), multiprocessor, microcontroller, digital signal processor (DSP), etc., capable of executing software instructions stored in a computer program product 1710a (as in FIG. 17), e.g. in the form of a storage medium 430. The processing circuitry 410 may further be provided as at least one application specific integrated circuit (ASIC), or field programmable gate array (FPGA).

Particularly, the processing circuitry 410 is configured to cause the mobile network operator entity 400 to perform a set of operations, or steps, A102, S104, S202-S208, as disclosed above. For example, the storage medium 430 may store the set of operations, and the processing circuitry 410 may be configured to retrieve the set of operations from the storage medium 430 to to cause the mobile network operator entity 400 to perform the set of operations. The set of operations may be provided as a set of executable instructions. Thus the processing circuitry 410 is thereby arranged to execute methods as herein disclosed.

The storage medium 430 may also comprise persistent storage, which, for example, can be any single one or combination of magnetic memory, optical memory, solid state memory or even remotely mounted memory.

The mobile network operator entity 400 may further comprise a communications interface 420 for communications with the subscriber entity 200, the subscription management entity 300, and the profile handling unit 250, 260. As such the communications interface 420 may comprise one or more transmitters and receivers, comprising analogue and digital components.

The processing circuitry 410 controls the general operation of the mobile network operator entity 400 e.g. by sending data and control signals to the communications interface 420 and the storage medium 430, by receiving data and reports from the communications interface 420, and by retrieving data and instructions from the storage medium 430. Other components, as well as the related functionality, of the mobile network operator entity 400 are omitted in order not to obscure the concepts presented herein.

FIG. 12 schematically illustrates, in terms of a number of functional modules, the components of a mobile network operator entity 400 according to an embodiment. The mobile network operator entity 400 of FIG. 12 comprises a number of functional modules; a receive module 410a configured to perform steps S102, S202, and a provide module 410b configured to perform steps S104, S204. The mobile network operator entity 400 of FIG. 12 may further comprise a number of optional functional modules, such as any of a receive module 410c configured to perform step S206 and a remove module 410d configured to perform step S208. In general terms, each functional module 410a-410d may be implemented in hardware or in software. Preferably, one or more or all functional modules 410a-410d may be implemented by the processing circuitry 410, possibly in cooperation with functional units 420 and/or 430. The processing circuitry 410 may thus be arranged to from the storage medium 430 fetch instructions as provided by a functional module 410a-410d and to execute these instructions, thereby performing any steps of the mobile network operator entity 400 as disclosed herein.

FIG. 13 schematically illustrates, in terms of a number of functional units, the components of a subscription management entity 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1710b (as in FIG. 17), e.g. in the form of a storage medium 330. The processing circuitry 310 may further be provided as at least one application specific integrated circuit (ASIC), or field programmable gate array (FPGA).

Particularly, the processing circuitry 310 is configured to cause the subscription management entity 300 to perform a set of operations, or steps, S104, S106, S108, S302-S310, as disclosed above. For example, the storage medium 330 may store the set of operations, and the processing circuitry 310 may be configured to retrieve the set of operations from the storage medium 330 to cause the subscription management entity 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The subscription management entity 300 may further comprise a communications interface 320 for communications with the subscriber entity 200, the mobile network operator entity 400, and the profile handling unit 250, 260. As such the communications interface 320 may comprise one or to more transmitters and receivers, comprising analogue and digital components.

The processing circuitry 310 controls the general operation of the subscription management entity 300 e.g. by sending data and control signals to the communications interface 320 and the storage medium 330, by receiving data and reports from the communications interface 320, and by retrieving data and instructions from the storage medium 330. Other components, as well as the related functionality, of the subscription management entity 300 are omitted in order not to obscure the concepts presented herein.

FIG. 14 schematically illustrates, in terms of a number of functional modules, the components of a subscription management entity 300 according to an embodiment. The subscription management entity 300 of FIG. 14 comprises a number of functional modules; an obtain module 310a configured to perform steps S104, S302, a generate module 310b configured to perform steps S106 S304, and an enable module 310e configured to perform steps S108, S310. The subscription management entity 300 of FIG. 14 may further comprise a number of optional functional modules, such as any of a receive module 310c configured to perform step S306, and a validate module 310d configured to perform step S308. In general terms, each functional module 310a-310e may be implemented in hardware or in software. Preferably, one or more or all functional modules 310a-310e may be implemented by the processing circuitry 310, possibly in cooperation with functional units 320 and/or 330. The processing circuitry 310 may thus be arranged to from the storage medium 330 fetch instructions as provided by a functional module 310a-310e and to execute these instructions, thereby performing any steps of the subscription management entity 300 as disclosed herein.

The subscription management entity 300 may be provided as a standalone device or as a part of at least one further device. For example, the subscription management entity 300 may be provided in a node of the service network or in a node of the core network. Alternatively, functionality of the subscription management entity 300 may be distributed between at least two devices, or nodes. These at least two nodes, or devices, may either be part of the same network part (such as the service network or the core network) or may be spread between at least two such network parts.

Thus, a first portion of the instructions performed by the subscription management entity 300 may be executed in a first device, and a second portion of the of the instructions performed by the subscription management entity 300 may be executed in a second device; the herein disclosed embodiments are not limited to any particular number of devices on which the instructions performed by the subscription management entity 300 may be executed. Hence, the methods according to the herein disclosed embodiments are suitable to be performed by a subscription management entity 300 residing in a cloud computational environment. Therefore, although a single processing circuitry 310 is illustrated in FIG. 13 the processing circuitry 310 may be distributed among a plurality of devices, or nodes. The same applies to the functional modules 310a-310e of FIG. 14 and the computer program 1720b of FIG. 11 (see below).

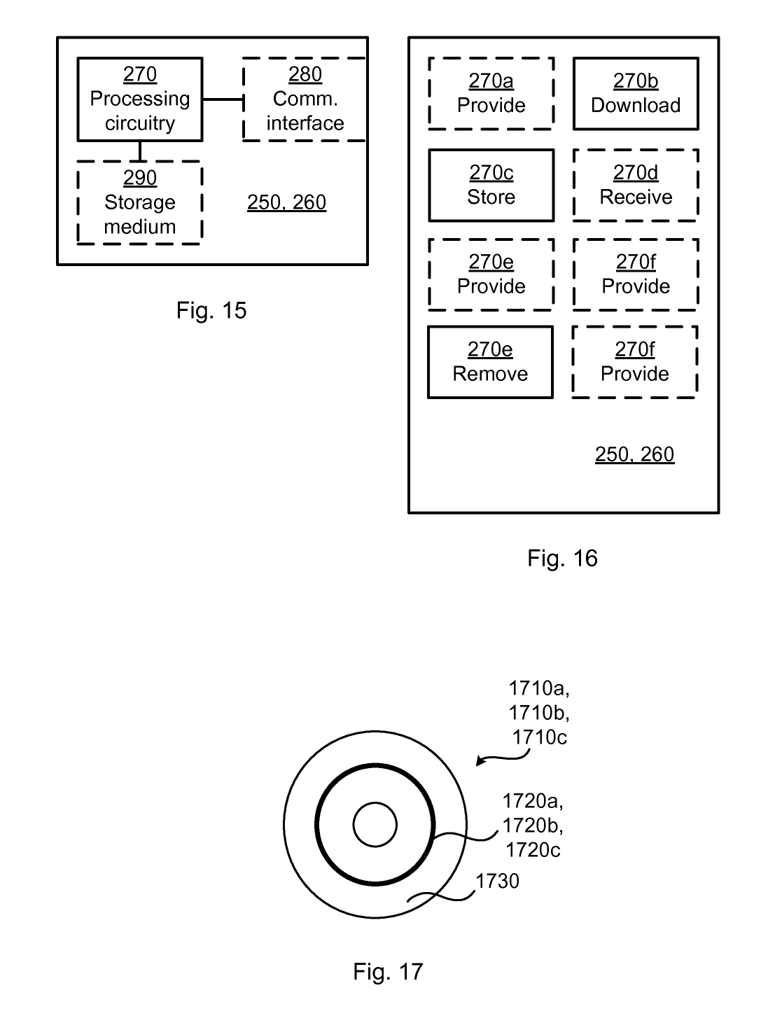

FIG. 15 schematically illustrates, in terms of a number of functional units, the components of a profile handling unit 250, 260 according to an embodiment. Processing circuitry 270 is provided using any combination of one or more of a suitable central processing unit (CPU), multiprocessor, microcontroller, digital signal processor (DSP), etc., capable of executing software instructions stored in a computer program product 1710c (as in FIG. 17), e.g. in the form of a storage medium 290. The processing circuitry 270 may further be provided as at least one application specific integrated circuit (ASIC), or field programmable gate array (FPGA).

Particularly, the processing circuitry 410 is configured to cause the profile handling unit 250, 260 to perform a set of operations, or steps, S108, S110, S402-S416, as disclosed above. For example, the storage medium 290 may store the set of operations, and the processing circuitry 270 may be configured to retrieve the set of operations from the storage medium 290 to cause the profile handling unit 250, 260 to perform the set of operations. The set of operations may be provided as a set of executable instructions. Thus the processing circuitry 270 is thereby arranged to execute methods as herein disclosed.

The storage medium 290 may also comprise persistent storage, which, for example, can be any single one or combination of magnetic memory, optical memory, solid state memory or even remotely mounted memory.

The profile handling unit 250, 260 may further comprise a communications interface 280 for communications with the subscriber entity 200, the subscription management entity 300, and the mobile network operator entity 400. As such the communications interface 280 may comprise one or more transmitters and receivers, comprising analogue and digital components.

The processing circuitry 270 controls the general operation of the profile handling unit 250, 260 e.g. by sending data and control signals to the communications interface 280 and the storage medium 290, by receiving data and reports from the communications interface 280, and by retrieving data and instructions from the storage medium 290. Other components, as well as the related functionality, of the profile handling unit 250, 260 are omitted in order not to obscure the concepts presented herein.

FIG. 16 schematically illustrates, in terms of a number of functional modules, the components of a profile handling unit 250, 260 according to an embodiment. The profile handling unit 250, 260 of FIG. 16 comprises a number of functional modules; a download module 270b configured to perform steps S108, S404, a store module 270c configured to perform steps S108, S406, and a remove module 270e configured to perform steps Silo, S414. The profile handling unit 250, 260 of FIG. 16 may further comprise a number of optional functional modules, such as any of a provide module 270a configured to perform step S402, a receive module 270d configured to perform step S408, a provide module 270e configured to perform step S410, a provide module 270f configured to perform step S412, and a provide module 270f configured to perform step S416. In general terms, each functional module 270a-270f may be implemented in hardware or in software. Preferably, one or more or all functional modules 270a-270f may be implemented by the processing circuitry 270, possibly in cooperation with functional units 280 and/or 290. The processing circuitry 270 may thus be arranged to from the storage medium 290 fetch instructions as provided by a functional module 270a-270f and to execute these instructions, thereby performing any steps of the profile handling unit 250, 260 as disclosed herein.

FIG. 17 shows one example of a computer program product 1710a, 1710b, 1710c comprising computer readable means 1730. On this computer readable means 1730, a computer program 1720a can be stored, which computer program 1720a can cause the processing circuitry 410 and thereto operatively coupled entities and devices, such as the communications interface 420 and the storage medium 430, to execute methods according to embodiments described herein. The computer program 1720a and/or computer program product 1710a may thus provide means for performing any steps of the mobile network operator entity 400 as herein disclosed. On this computer readable means 1730, a computer program 1720b can be stored, which computer program 1720b can cause the processing circuitry 310 and thereto operatively coupled entities and devices, such as the communications interface 320 and the storage medium 330, to execute methods according to embodiments described herein. The computer program 1720b and/or computer program product 1710b may thus provide means for performing any steps of the subscription management entity 300 as herein disclosed. On this computer readable means 1730, a computer program 1720c can be stored, which computer program 1720c can cause the processing circuitry 270 and thereto operatively coupled entities and devices, such as the communications interface 280 and the storage medium 290, to execute methods according to embodiments described herein. The computer program 1720c and/or computer program product 1710c may thus provide means for performing any steps of the profile handling unit 250, 260 as herein disclosed.

In the example of FIG. 17, the computer program product 1710a, 1710b, 1710c is illustrated as an optical disc, such as a CD (compact disc) or a DVD (digital versatile disc) or a Blu-Ray disc. The computer program product 1710a, 1710b, 1710c could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1720a, 1720b, 1720c is here schematically shown as a track on the depicted optical disk, the computer program 1720a, 1720b, 1720c can be stored in any way which is suitable for the computer program product 1710a, 1710b, 1710c.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-33. (canceled)

34. A method for providing a subscriber entity with a time-bounded network subscription, the method being performed by a mobile network operator (MNO) entity of the subscriber entity, the method comprising:
receiving a request for the time-bounded network subscription for the subscriber entity, wherein the time-bounded network subscription is to be limited to a specified time period; and
providing, to a subscription management entity, subscription information of the time-bounded network subscription, wherein the subscription information comprises a parameter indicating that the time-bounded network subscription is to be limited to the specified time period.

35. The method according to claim 34, further comprising:
removing the time-bounded network subscription from the MNO entity upon expiry of the specified time period.

36. The method according to claim 34, further comprising:
receiving an indication from a profile handling unit of the subscriber entity that the profile is to be removed from the subscriber entity.

37. The method according to claim 34, wherein the specified time period has a duration set by the MNO entity.

38. A method for providing a subscriber entity with a time-bounded network subscription, the method being performed by a subscription management entity, the method comprising:
obtaining, from a mobile network operator (MNO) entity of the subscriber entity, subscription information of the time-bounded network subscription for the subscriber entity, wherein the subscription information comprises a parameter indicating that the time-bounded network subscription is to be limited to a specified time period;
generating a profile for the time-bounded network subscription, wherein the profile comprises metadata defining the specified time period; and
enabling download of the profile to a profile handling unit of the subscriber entity.

39. The method according to claim 38, further comprising:
receiving an activation code token for the profile from the profile handling unit; and
validating the activation code token, wherein download of the profile is only enabled if the activation code token is found valid.

40. The method according to claim 38, wherein the metadata is provided in a bounded profile package (BPP).

41. The method according to claim 38, wherein the specified time period has a duration set by the subscription management entity.

42. A method for providing a subscriber entity with a time-bounded network subscription, the method being performed by a profile handling unit of the subscriber entity, the method comprising:
downloading the profile of the time-bounded network subscription from a subscription management entity, wherein the profile comprises metadata defining a specified time period for which the time-bounded network subscription is to be limited;
storing the metadata; and
removing the profile from the subscriber entity upon expiry of the specified time period.

43. The method according to claim 42, further comprising:
providing an activation code token for the profile to the subscription management entity, wherein the profile is downloaded in response thereto.

44. The method according to claim 42, further comprising:
receiving a user query about remaining time of the specified time period; and
providing a response to the user query based on the metadata.

45. The method according to claim 42, further comprising:
providing an indication towards a user interface controller that the profile has been removed from the subscriber entity.

46. The method according to claim 42, further comprising:
providing an indication to a mobile network operator (MNO) entity of the subscriber entity that the profile is to be removed from the subscriber entity.

47. The method according to claim 42, wherein the specified time period is provided as a number of seconds.

48. The method according to claim 47, wherein the number of seconds is counted from provisioning of the time-bounded network subscription.

49. The method according to claim 47, wherein the number of seconds is counted from a first network authentication of the profile.

50. The method according to claim 42, wherein the specified time period is provided as a timestamp indicating a point in time for expiry of the specified time period.

51. A mobile network operator (MNO) entity configured for providing a subscriber entity with a time-bounded network subscription, the MNO entity comprising:
processing circuitry; and
a storage medium storing instructions that, when executed by the processing circuitry, cause the MNO entity to:
receive a request for the time-bounded network subscription for the subscriber entity, wherein the time-bounded network subscription is to be limited to a specified time period; and
provide, to a subscription management entity, subscription information of the time-bounded network subscription, wherein the subscription information comprises a parameter indicating that the time-bounded network subscription is to be limited to the specified time period.

52. A subscription management entity configured for providing a subscriber entity with a time-bounded network subscription, the subscription management entity comprising:
processing circuitry; and
a storage medium storing instructions that, when executed by the processing circuitry, cause the subscription management entity to:
obtain, from a mobile network operator (MNO) entity of the subscriber entity, subscription information of the time-bounded network subscription for the subscriber entity, wherein the subscription information comprises a parameter indicating that the time-bounded network subscription is to be limited to a specified time period;
generate a profile for the time-bounded network subscription, wherein the profile comprises metadata defining the specified time period; and
enable download of the profile to a profile handling unit of the subscriber entity.

53. A profile handling unit configured for providing a subscriber entity with a time-bounded network subscription, the profile handling unit comprising:
processing circuitry; and
a storage medium storing instructions that, when executed by the processing circuitry, cause the profile handling unit to:
download a profile of the time-bounded network subscription from a subscription management entity, wherein the profile comprises metadata defining a specified time period for which the time-bounded network subscription is to be limited;
store the metadata; and
remove the profile from the subscriber entity upon expiry of the specified time period.
